(19) United States
(12) Patent Application Publication
(10) Pub. No.: US 2013/0162066 A1
(43) Pub. Date: Jun. 27, 2013

(54) Electrical Machine for a Wind Energy Installation

(71) Applicant: Robert Bosch GmbH, Stuttgart (DE)

(72) Inventors: Isabella Stamm, Steinfeld (DE); Andreas Vath, Leidersbach (DE)

(73) Assignee: Robert Bosch GmbH, Stuttgart (DE)

(21) Appl. No.: 13/720,815

(22) Filed: Dec. 19, 2012

(30) Foreign Application Priority Data
Dec. 24, 2011 (DE) 10 2011 122 411.8
Feb. 8, 2012 (DE) 10 2012 002 347.2

(51) Int. Cl. H02K 21/38; H02K 7/116

(52) U.S. Cl. CPC H02K 21/38; H02K 7/116
USPC 310/46; 310/83

(57) ABSTRACT

An electrical machine includes a stationary secondary part which is self-excited or externally excited, a stationary primary part with a primary winding element, and a rotatably mounted magnetic modulator, which modulates a magnetic flux density. The magnetic modulator is arranged between the secondary part and the primary part or the primary part is arranged between the secondary part and the magnetic modulator.

This application claims priority under 35 U.S.C. §119 to both (i) patent application no. DE 10 2011 122 411.8, filed on Dec. 24, 2011 in Germany, and (ii) DE 10 2012 002 347.2, filed on Feb. 8, 2012 in Germany. The disclosures of the above-identified patent applications are both incorporated herein by reference in their entirety.

### BACKGROUND

The present disclosure relates to an electrical machine for a wind energy installation. However, it should be emphasized that the electrical machine can also be advantageously used in other areas and can be employed both as a generator for generating power and as a motor for generating movement.

A large proportion of the existing wind energy installations are equipped with rapidly rotating generators, with multi-stage gear mechanisms being employed to convert the relatively slow rotation speed of the wind turbine into the generator rotation speed. In addition, generators which are coupled to the wind turbine without a gear mechanism are also employed. In order to implement the concept of the direct drive, the generators are designed as multi-pole, slowly rotating, permanently excited synchronous machines.

However, this design leads to a significant increase in weight in comparison to installations with gear mechanisms since the secondary parts (rotor) of the generators have relatively large diameters and are connected to the drive shaft (hub of the wind turbine) by means of solid connecting elements, for example spokes. The multi-pole magnetic circuit of the directly driven machines has a considerably larger circumference than a magnetic circuit of a rapidly rotating 4- or 6-pole, doubly fed asynchronous machine. Considerably larger torques occur as a result, said torques having to be transmitted from the hub to the secondary part. An example of a permanently excited synchronous machine of this kind is shown in US 2004/0155537 A1.

It is therefore desirable to specify an electrical machine for a wind energy installation, in which the transmission of torque is improved and, in particular, weight can be saved.

### SUMMARY

A measure of the disclosure is to combine a magnetic gear mechanism physically with the electrical machine. Overall, the electrical machine has a stationary primary part with a primary winding element, a similarly stationary self-excited or externally excited secondary part, and a rotating magnetic modulator which modulates the magnetic field which is generated by the secondary part. In this way, induction voltage and frequency in the primary winding element can be considerably increased. The modulator can be arranged between the primary part and the secondary part, that is to say secondary part—modulator—primary part. As an alternative, an arrangement of the kind secondary part—primary part—modulator is also possible. As a result, the gear mechanism/generator unit manages with just three functional components, but with just one of said components having to be moved. This simplifies construction and storage.

The magnetic modulator can be composed of alternately ferromagnetic and non-ferromagnetic components. A supporting structure or a frame of the modulator is preferably composed of a non-ferromagnetic material, for example aluminum. The supporting structure can have, for example, at least two non-ferromagnetic rings which are connected by similarly not non-ferromagnetic struts. Ferromagnetic components can then be inserted between the struts, preferably in the manner of a tongue-and-groove fastening means. A modulator can also comprise a plurality of such supporting structures which are connected, for example screwed, to one another.

The described (magnetic) gear mechanism/generator unit is once again driven by a mechanical gear mechanism arrangement. A drive shaft of the gear mechanisms arrangement can be driven, for example, by a rotor of a wind energy installation or the like. In this case, the high force density of the mechanical torque or power transmission is coupled to the magnetic. The electrical machine with the integrated magnetic gear mechanism fulfills a double function in this combination: in the first instance, the magnetic gear mechanism serves to increase the voltage and frequency in the coil windings of the electrical machine (during operation as a generator) and therefore also to generate electrical energy with a very high degree of efficiency since, in particular, the resistive losses can be considerably reduced.

The amplitude and frequency of the induction voltage in the primary winding element of the generator can be set in a very deliberate manner by a corresponding selection of the number and arrangement of the ferromagnetic and non-ferromagnetic modulator components. In this case, mechanical and magnetic transmission ratios are designed such that the total costs of the gear mechanism/generator unit are as low as possible, but with it being possible to achieve a very high degree of efficiency.

It is further advantageous to insert an electrical insulation means between the gear mechanism and the electrical machine in order to protect the gear mechanism from damage by so-called bearing currents. As an alternative or in addition, the gear mechanism can be earthed, for example by slip rings on the output drive shafts. In this way, the potential can be reduced such that bearing currents no longer occur. The insulation means can also be integrated in a coupling.

According to a preferred embodiment, the insulation means is integrated in a plug-in coupling, with pins which are coated with insulating material, for example elastomer, being inserted into associated cutouts, or with pins being inserted into cutouts which are lined with insulating material, for example elastomer. In this way, a simple coupling can be provided with electrical insulation at the same time, with the coupling still being able to transmit a high torque.

The combination of a mechanical gear mechanism with the gear mechanism/generator unit additionally allows the housing structure of the mechanical gear mechanism to be used in order to absorb at least a portion of the torque, the weight force and further forces of the electrical machine. This leads to a saving of material and installation space. The combination also allows at least an output drive shaft of the mechanical gear mechanism to be mounted by means of the electrical machine, or vice versa, and thus at least one bearing point in the entire arrangement to be dispensed with.

If the output drive shaft is connected to an obliquely toothed gear of the gear mechanism arrangement and/or mounted with a conical roller bearing, axial forces can be particularly effectively supported. If, in this case, the angle of inclination of the tooth system and the conical angle of the conical roller bearing are selected such that the resulting axial forces counteract one another, that is to say cancel one another out, smaller sizes can be selected for the conical roller bearing and therefore costs can be saved. In this way, an axial movement in the drive train is also reduced, this having a positive effect on the development of noise and wear. Overall, obliquely toothed gear mechanisms are usually quieter than straight-toothed gear mechanisms.

If the output drive shaft is connected to a straight-toothed gear of the gear mechanism arrangement and/or mounted with a cylindrical roller or ball bearing, this has a positive effect on the degree of efficiency.

It is advantageous to insert a coupling between a planetary gear mechanism and the electrical machine, said coupling allowing the sun gear in the planetary gear mechanism to be optimally oriented in relation to the tooth system. In order to protect the drive train in the case of a short circuit in the generator, given appropriate design, the magnetic modulator can also operate as a safety coupling and therefore considerably reduce the load on the drive train. In this case, magnetically conductive parts of the magnetic modulator are saturated, and therefore the transmittable torque is limited.

A brake which serves to brake the arrangement is expediently fitted on that side of the gear mechanism/generator unit which does not face the mechanical gear mechanism.

A torque ripple can be reduced by corresponding operation of the generator, in particular by the electrical connection of the primary winding elements. This can be done by corresponding actuation of a current converter (for example rectifier with transistor switches) which is connected downstream of the primary winding element. This leads to lower loading on the entire drive train and to lower noise emissions by the gear mechanism/generator unit.

The gear mechanism arrangement preferably comprises a plurality of gear mechanism stages, in particular two. Said gear mechanism stages can be connected in series or in parallel (as power splits). An asymmetrical power split (for example 75:25) can be provided, with one input stage of the gear mechanism arrangement preferably transmitting a higher power than the second stage. As a result, transmission ratios, in particular relatively large transmission ratios, are possible, these meaning the design of the generators is simplified.

The principle of the electrical machine used can be a generator with permanent-magnet excitation (that is to say a self-excited generator) and/or an electrically excited (that is to say externally excited) generator of the various designs of radial flux generators and/or axial flux generators and/or transverse flux generators and/or generators with a full-pitch winding and/or supraconducting generators.

The use of an electrical machine according to the disclosure for generating power in power plants, in particular in wind energy installations, but also in wave, tide or water power plants, is particularly advantageous.

Further advantages and refinements of the disclosure can be found in the description and the appended drawing.

It goes without saying that the features cited above and those still to be explained in the text which follows can be used both in the respectively indicated combination and also in other combinations or on their own, without departing from the scope of the present disclosure.

The disclosure is schematically illustrated in the drawing using exemplary embodiments and will be described in detail in the text which follows with reference to the drawing.

### BRIEF DESCRIPTION OF THE DRAWINGS

FIG. 1 shows a longitudinal sectional view through a first preferred embodiment of an electrical machine according to the disclosure having a planetary gear mechanism arrangement.

FIG. 2 shows a rear view of the electrical machine according to FIG. 1.

FIG. 3 shows a longitudinal sectional view through a second preferred embodiment of an electrical machine according to the disclosure having a planetary gear mechanism arrangement and an insulation means.

FIG. 4 schematically shows a preferred plug-in coupling with an insulation means for coupling a mechanical gear mechanism arrangement to the electrical machine.

### DETAILED DESCRIPTION

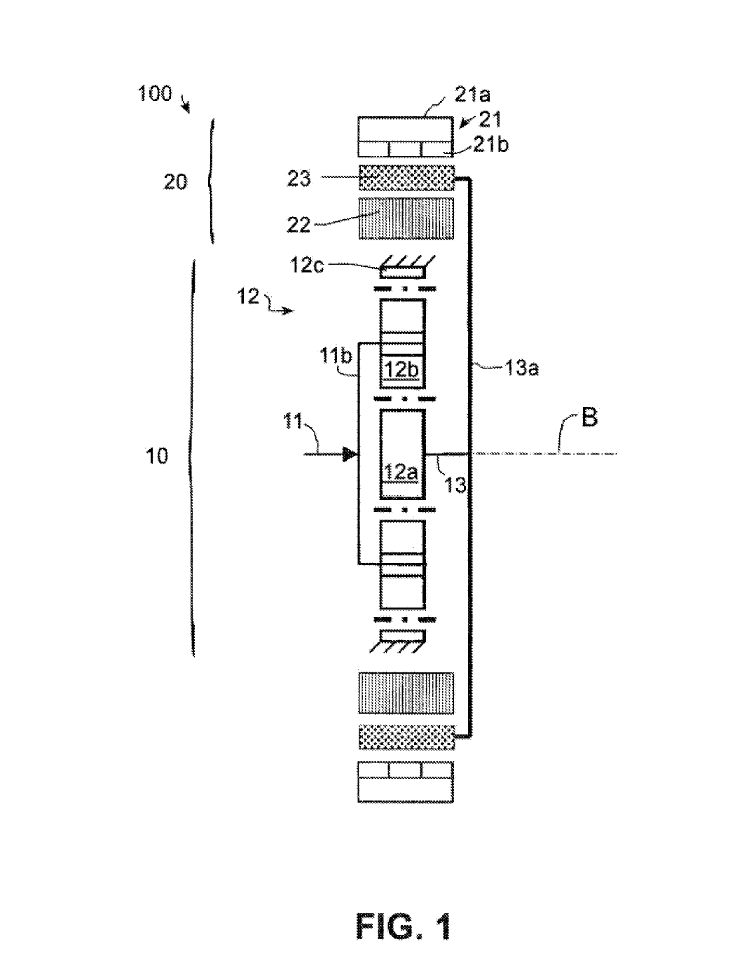

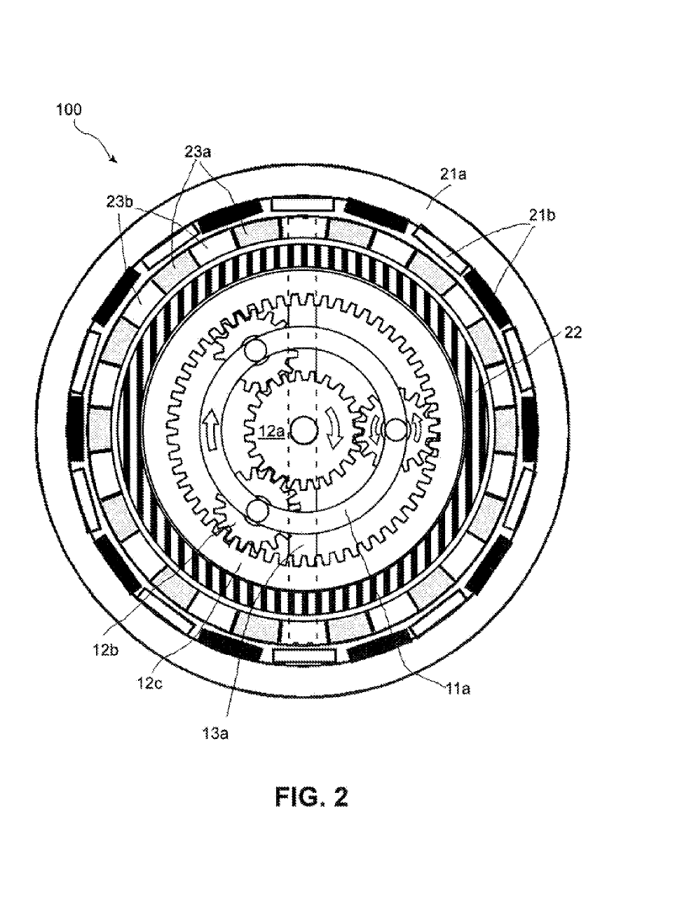

In FIGS. 1 to 4, identical elements are provided with identical reference symbols. First, FIGS. 1 and 2 are described coherently and comprehensively, said figures showing a first preferred embodiment of an electrical machine according to the disclosure in a longitudinal and cross-sectional view.

The electrical machine is designated 100 overall. In the embodiment shown, it has a planetary gear mechanism arrangement 10 and an integrated (magnetic) gear mechanism/generator unit 20 which connects the function of a magnetic gear mechanism with the current-generating function of the electrical machine.

The planetary gear mechanism 10 comprises a drive shaft 1 which drives a planetary gear mechanism stage 12. The drive shaft 11 is connected to planetary gears 12b of the planetary gear mechanism stage 12 by means of a web 11b. A hollow gear 12c is arranged in a rotationally fixed manner, a sun gear 12a drives an output drive shaft 13.

The manner of operation for generating current will now be explained below.

The electrical machine has a stationary secondary part 21 and a stationary primary part 22. In the example shown, the secondary part is externally excited, that is to say provided with a permanent-magnet arrangement 2 lb which are arranged on a ferromagnetic carrier ring 21a for the magnetic return path. In the example according to FIG. 2, the secondary part has ten pole pairs.

The primary part 22 is equipped with a number of primary winding elements in which a current is induced by the change in the magnetic flux density. A magnetic modulator 23 is arranged in a rotatable manner between the secondary part 21 and the primary part 22 for this purpose, said magnetic modulator modulating the magnetic flux density between the secondary part 21 and the primary part 22. The magnetic modulator 23 has a number of ferromagnetic elements 23a for this purpose, with in each case two adjacent ferromagnetic elements 23a being separated by a non-ferromagnetic element 23b. The ferromagnetic elements can be composed, for example, of an iron/nickel alloy, whereas the non-ferromagnetic elements 23b are composed of air in the simplest case but can also be composed of non-ferromagnetic material, for example aluminum.

One possible way of simply providing a preferred magnetic modulator 23 involves providing a non-ferromagnetic frame, for example composed of aluminum, into which the ferromagnetic elements are inserted. The ferromagnetic magnets 23a can be attached to a frame of this kind, for example, in the manner of a tongue-and-groove connection, this simplifying attachment. The frame can be in the form of a cage and comprise two rings between which struts extend in an axial manner.

The output drive shaft 13 is connected to the magnetic modulator 23 by means of a web 13a.

As a result, the modulator rotates about a rotation axis B.

This refinement leads to a significant increase in the induction voltage in the primary part 22 due to the increased frequency of change in the magnetic flux density. This allows a compact (in this case narrow) design for the current-generating parts of the electrical machine, in particular for the secondary part 21 and the primary part 22 since a frequent change in the magnetic flux density does not have to be achieved by a correspondingly high number of pole pairs on the secondary part.

In addition to the arrangement shown in FIG. 1, in which the secondary part is arranged on the outside, the modulator is arranged in the center and the primary part is arranged on the inside, arrangements in which
the primary part is arranged on the outside, the modulator is arranged in the center and the secondary part is arranged on the inside,
the modulator is arranged on the outside, the primary part is arranged in the center and the secondary part is arranged on the inside, or
the secondary part is arranged on the outside, the primary part is arranged in the center and the modulator is arranged on the inside are likewise advantageous.

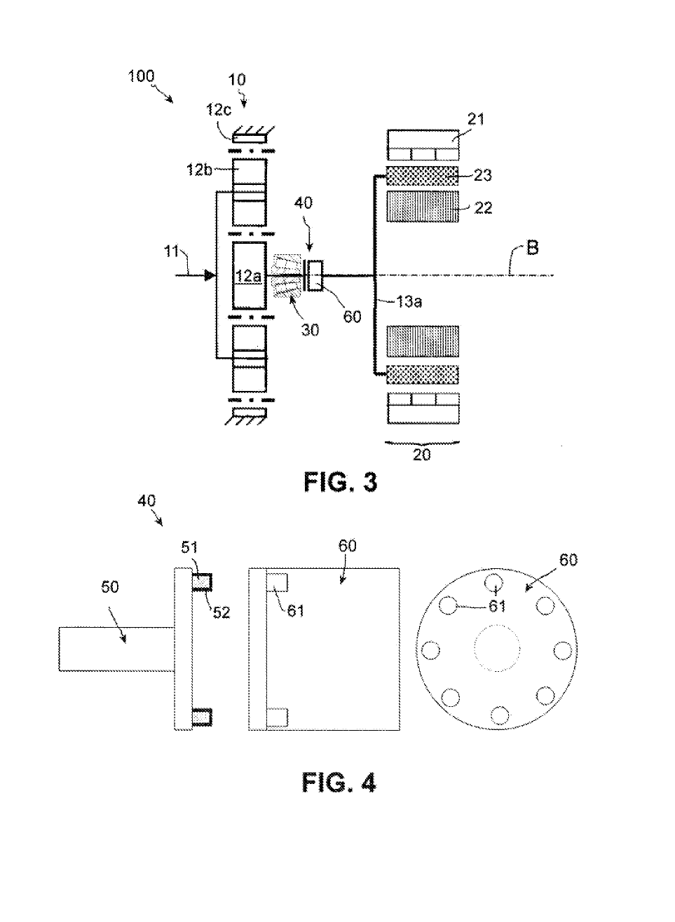

FIG. 3 shows a longitudinal sectional view through a second preferred embodiment of an electrical machine according to the disclosure. FIG. 4 schematically shows a preferred plug-in coupling with an insulation means for coupling a mechanical gear mechanism arrangement to the electrical machine, as is also shown in FIG. 3. It should be noted that the coupling can likewise advantageously be used in another embodiment, in particular according to FIGS. 1 and 2.

The electrical machine according to FIG. 3 differs from the electrical machine according to FIGS. 1 and 2 substantially by virtue of a different arrangement of the gear mechanism/generator unit 20. In contrast to FIG. 1, said arrangement does not surround the gear mechanism arrangement 10 in FIG. 3, but rather is arranged next to it. This leads to an extension of the installation but at the same time to a reduction in the total diameter.

FIG. 3 shows three further features for the first time; however, these features are independent of the specific refinement of the electrical machine and also independent of one another. Said features could likewise be implemented in FIGS. 1 and 2.

The sun gear 12C of the planetary gear mechanism 12 has an oblique tooth system in the embodiment according to FIG. 3. As a result, an (in particular varying) axial force, which acts on the drive shaft 12, for example on account of a wind force, can be better supported. Furthermore, an oblique tooth system leads to a reduction in noise.

In addition, the output drive shaft 13 of the gear mechanism arrangement 10 is mounted in a conical roller bearing, and therefore axial forces which are created in a wind energy installation, in particular by the wind pressure on the drive shaft 11, are likewise well supported.

Finally, an electrically insulating coupling 40 is arranged between the gear mechanism arrangement 10 and the gear mechanism/generator unit 20, said coupling firstly electrically insulating the gear mechanism arrangement 10 from the magnetic gear mechanism/generator unit 20 and thereby preventing damaging bearing currents, it nevertheless being possible to transmit a high torque, and secondly leading to a connection between the gear mechanism arrangement 10 and the gear mechanism/generator unit 20 which can be established and released in a quick and simple manner.

The coupling 40 will be explained in greater detail below with reference to FIG. 4.

The coupling 40 is in the form of a plug-in coupling in which a first coupling element 50 is inserted into a second coupling element 60. The first coupling element 50 can be attached, in particular, to the output drive shaft 13, and the second coupling element 60 can be attached to the web 13a.

The first coupling element 50 has pins 51 which are inserted into corresponding cutouts 61 in the second coupling element 60. For the purpose of electrical insulation, the pins 51 are coated with an electrically insulating material 52, in particular an elastomer such as rubber.

The coupling 40 is easy to close and to release, electrically insulates the coupled components from one another and can nevertheless transmit a high torque.

What is claimed is:

1. An electrical machine comprising:
a stationary secondary part which is self-excited or externally excited;
a stationary primary part including a primary winding element; and
a rotatably mounted magnetic modulator which modulates a magnetic flux density, the magnetic modulator being arranged between the secondary part and the primary part or the primary part being arranged between the secondary part and the magnetic modulator.

2. The electrical machine according to claim 1, further comprising:
a gear mechanism arrangement having a drive shaft and an output drive shaft to which the magnetic modulator is connected.

3. The electrical machine according to claim 2, wherein the gear mechanism arrangement includes a planetary gear mechanism and/or a spur gear mechanism.

4. The electrical machine according to claim 2, wherein an electrical insulation means is arranged between the gear mechanism arrangement and the magnetic modulator.

5. The electrical machine according to claim 1, wherein the magnetic modulator includes a number of ferromagnetic elements which are arranged in a spaced-apart manner.

6. The electrical machine according to claim 5, wherein in each case two adjacent ferromagnetic elements are separated by a non-ferromagnetic element.

7. The electrical machine according to claim 5, wherein the secondary part includes fewer magnetic pole pairs than the modulator has ferromagnetic elements.

8. The electrical machine according to claim 4, wherein the electrical insulation means is integrated in a coupling configured to connect the output drive shaft of the gear mechanism arrangement to the magnetic modulator.

9. The electrical machine according to claim 8, wherein the coupling is configured as a plug-in coupling including (i) pins which are coated with insulating material, such as elastomer, and are inserted into associated cutouts, or (ii) pins inserted into cutouts which are lined with insulating material, such as elastomer.

10. The electrical machine according to claim 2, wherein:
the secondary part, the primary part, and magnetic modulator are each of cylindrical design, and
the secondary part, the primary part, and magnetic modulator are each configured to surround the gear mechanism arrangement.

11. The electrical machine according to claim 2, wherein the magnetic modulator is mounted jointly with the output drive shaft.

12. The electrical machine according to claim 2, wherein the output drive shaft is connected to an obliquely toothed gear of the gear mechanism arrangement and/or is mounted with a conical roller bearing.

13. The electrical machine according to claim 2, wherein the gear mechanism arrangement includes a coaxial gear mechanism.

14. The electrical machine according to claim 2, wherein the output drive shaft is electrically connected to earth by means of slip rings.

15. A wind energy installation, comprising:
an electrical machine including (i) a stationary secondary part which is self-excited or externally excited, (ii) a stationary primary part including a primary winding element, and (iii) a rotatably mounted magnetic modulator which modulates a magnetic flux density, the magnetic modulator being arranged between the secondary part and the primary part or the primary part being arranged between the secondary part and the magnetic modulator.
